(19) United States
(12) Patent Application Publication
(10) Pub. No.: US 2019/0004016 A1
(43) Pub. Date: Jan. 3, 2019

(54) CHROMATOGRAPH DEVICE

(71) Applicant: Shimadzu Corporation, Kyoto (JP)

(72) Inventor: Kenta MATSUMOTO, Kyoto (JP)

(73) Assignee: Shimadzu Corporation, Kyoto (JP)

(21) Appl. No.: 16/065,314

(22) PCT Filed: May 17, 2016
(86) PCT No.: PCT/JP2016/064540

§ 371 Date: Jun. 22, 2018

(30) Foreign Application Priority Data
Jan. 26, 2016 (JP) 2016-012138

(51) Int. Cl. G01N 30/18; G01N 30/28; G01N 30/72

(52) U.S. Cl. CPC G01N 30/18; G01N 2030/027; G01N 30/7233; G01N 30/28

(57) ABSTRACT

A chromatograph device which makes it possible to suppress a carry-over phenomenon. A sample injection unit for collecting a liquid sample and injecting a predetermined amount of liquid sample into a mobile phase; a sample introduction tube a distal end section of which has a needle formed therein and a terminal end section of which is connected to the sample injection unit; a separation column which is coupled via a column coupling tube to the sample injection unit, and through which the mobile phase where the liquid sample has been injected passes; and a detection unit that is connected to the separation column and detects a component in the liquid sample. The column coupling tube is provided with an ultrasonic vibrator for vibrating the tube.

### TECHNICAL FIELD

The present invention relates to a chromatograph device and, more particularly, to a liquid chromatograph device measuring multiple liquid samples.

### BACKGROUND ART

A liquid chromatography mass spectrometer (LC/MS) includes a liquid chromatograph section (LC section) separating and eluting a liquid sample by component, an ionization chamber ionizing the sample components eluted from the LC section, and a mass spectrometer section (MS section) detecting the ions introduced from the ionization chamber.

FIGS. 3 and 4 are schematic configuration diagrams illustrating an example of a general LC/MS. A LC/MS 101 is provided with a mobile phase reservoir 10 storing a mobile phase, a feed pump 11 connected to the mobile phase reservoir 10, a column coupling tube (column IN side piping) 12, a separation column 13 coupled to the column coupling tube 12, a column thermostat 14 keeping the separation column 13 at a substantially constant temperature, a detector (detection unit) 15 connected to the separation column 13, an auto-sampler 20 injecting a liquid sample into the mobile phase, and a controller 140 controlling the LC/MS 101, (see, for example, Patent Document 1).

The auto-sampler 20 is provided with a table 21 where multiple sample vials S are placed, a sample introduction tube 22 that has a distal end section where a stainless steel needle 22a is formed, a needle driver 23 that moves the needle 22a in up-down and horizontal directions, a rinse port 24 for cleaning the needle 22a, and a sample injector 30.

The sample vial S includes a cylindrical glass container that has a bottom surface and a silicon septum that is attached to an opening section of the glass container. A liquid sample is accommodated in the sample vial S.

The rinse port 24 is provided with a container 24a accommodating a rinse liquid (high-elution force solution).

The sample injector 30 is provided with a syringe pump 31, an injection port 32, a flow path switching valve 33 that has six ports a to f, and a flow path switching valve 34 that has seven ports g to m.

The syringe pump 31 is provided with a syringe 31a that is a cylindrical body, a columnar plunger 31b that is inserted into the syringe 31a, and a pulse motor 31c that moves the plunger 31b in the up-down direction. When the flow path switching valve 33 and the flow path switching valve 34 are in the state that is illustrated in FIG. 4, the syringe pump 31 injects the liquid sample into the sample introduction tube 22 once the plunger 31b is pulled downward and injects the cleaning solution accommodated in the syringe 31a into the sample introduction tube 22 once the plunger 31b is pushed upward.

The port a of the flow path switching valve 33 is connected to the mobile phase reservoir 10 via the feed pump 11. The port b of the flow path switching valve 33 is connected to the sample introduction tube 22. The port c of the flow path switching valve 33 is connected to the port k of the flow path switching valve 34. The port d of the flow path switching valve 33 is connected to a drain via an electromagnetic valve 35. The port e of the flow path switching valve 33 is connected to the injection port 32. The port f of the flow path switching valve 33 is connected to the column coupling tube 12. The ports a to f are configured such that those of the adjacent ports a to f that are next to each other are capable of communicating with each other.

The port g, the port h, and the port i of the flow path switching valve 34 are connected to a container 36 accommodating a cleaning solution. The port j of the flow path switching valve 34 is connected to the syringe pump 31. The port k of the flow path switching valve 34 is connected to the port c of the flow path switching valve 33. The port l of the flow path switching valve 34 is connected to the rinse port 24. The port m of the flow path switching valve 34 is connected to the syringe pump 31 via an electromagnetic valve 37. The port m is capable of communicating with any one of the ports g to l, and the ports g to l are configured such that those of the adjacent ports g to l that are next to each other are capable of communicating with each other.

An analysis method for automatically and continuously analyzing multiple liquid samples by using the LC/MS 101 will be described below. Firstly, the controller 140 controls the ports a to m of the flow path switching valves 33 and 34 such that the ports a to m are in the state that is illustrated in FIG. 4. Accordingly, the mobile phase supplied via the feed pump 11 from the mobile phase reservoir 10 is sent to the separation column 13 through the column coupling tube 12. Next, the controller 140 performs a movement such that a desired sample vial S comes directly below the needle 22a, and then inserts the needle 22a into the sample vial S by lowering the needle 22a. Then, the controller 140 fills the sample introduction tube 22 with the liquid sample in the sample vial S by pulling the plunger 31b.

Next, the controller 140 moves the injection port 32 such that the injection port 32 is directly below the needle 22a, and then inserts the needle 22a into the injection port 32 by lowering the needle 22a. Then, the controller 140 controls the ports a to m of the flow path switching valves 33 and 34 such that the ports a to m are in the state that is illustrated in FIG. 3. Accordingly, the mobile phase supplied via the feed pump 11 from the mobile phase reservoir 10 is sent to the column coupling tube 12 through the sample introduction tube 22, the needle 22a, and the injection port 32. At this time, the liquid sample with which the sample introduction tube 22 is filled is sent to the column coupling tube 12 with the mobile phase, is subjected to component separation in the separation column 13, and then is subjected to sequential detection by the detector 15.

Subsequently, the controller 140 controls the ports a to m of the flow path switching valves 33 and 34, such that the ports a to m are in the state that is illustrated in FIG. 4, after injecting the liquid sample into the column coupling tube 12. Next, the controller 140 moves the rinse port 24 such that the rinse port 24 is directly below the needle 22a, and then inserts the needle 22a into the rinse port 24 by lowering the needle 22a. Then, the controller 140 allows the cleaning solution in the container 36 of the sample injector 30 to flow into the sample introduction tube 22 by pulling and inserting the plunger 31b.

Subsequently, the controller 140 performs control for measuring the next liquid sample by the same procedure as above.

### CITATION LIST

### Patent Document

Patent Document 1: Domestic Re-publication of PCT patent Application 2011-27784

### SUMMARY OF THE INVENTION

### Technical Problem

In recent years, a so-called “carry-over” phenomenon has become a problem regarding the LC/MS 101 as described above as the detection sensitivity of the detector 15 increases. The “carry-over” is a phenomenon in which a component of a liquid sample measured in the past remains and a detection result is shown as if the component is present in a currently measured liquid sample.

### Solution to Problem

The applicant examined the cause of the carry-over phenomenon and found that a component in the previous liquid sample remains in the column coupling tube 12 without being removed during cleaning of the LC/MS 101, although the inside of the auto-sampler 20 (such as the needle 22a) is cleaned in a cleaned LC/MS 101, and this residual component is mixed with the next injected liquid sample and introduced to the detector 15.

The inside of the column coupling tube 12 as described above cannot be cleaned with a cleaning solution or the like because the mobile phase still flows in any of the states illustrated in FIGS. 3 and 4, and almost no measure was taken with regard to the carry-over phenomenon occurring in the column coupling tube 12. In a case where a cleaning solution is allowed to flow into the column coupling tube 12, the mobile phase needs to flow again for stabilization of the separation column 13, and then extra time is taken.

The applicant found that the component of the previous measurement sample remaining in the column coupling tube can be peeled off and removed by ultrasonic vibration instead of a flowing cleaning solution.

In other words, a chromatograph device according to the invention includes a sample injector for collecting a liquid sample and injecting a predetermined amount of liquid sample into a mobile phase, a sample introduction tube a distal end section of which has a needle formed therein and a terminal end section of which is connected to the sample injector, a separation column which is coupled via a column coupling tube to the sample injector, and through which the mobile phase where the liquid sample has been injected passes, and a detector that is connected to the separation column and detects a component in the liquid sample, in which the column coupling tube is provided with an ultrasonic vibrator for vibrating the tube.

Here, the “predetermined amount” is any amount determined by a measurer or the like during analysis and is, for example, 10 μl.

### Advantageous Effects of the Invention

In the chromatograph device according to the invention as described above, the inside of the column coupling tube is reliably cleaned, and thus the occurrence of a carry-over phenomenon can be suppressed. In addition, waiting time for stabilization of the separation column is unnecessary because a cleaning solution different from the mobile phase does not have to flow into the column coupling tube.

### Additional Solution to Problem and Advantageous Effects

In addition, the chromatograph device according to the invention includes a needle driver moving the needle and a table where a plurality of sample containers accommodating liquid samples are placed.

In addition, the chromatograph device includes a controller operating the ultrasonic vibrator between liquid sample measurement and liquid sample measurement.

In the chromatograph device according to the invention, a vibration frequency of the ultrasonic vibrator is 20 to 80 kHz inclusive.

Furthermore, in the chromatograph device according to the invention, the sample injector includes a syringe pump for collecting a predetermined amount of liquid sample and a port valve for interconnecting the syringe pump and the sample introduction tube or interconnecting the sample introduction tube and the column coupling tube.

### BRIEF DESCRIPTION OF THE DRAWINGS

FIG. 1 is a schematic configuration diagram illustrating an LC/MS as an example of a chromatograph device according to the invention.

FIG. 2 is a schematic configuration diagram illustrating the same LC/MS as in FIG. 1.

FIG. 3 is a schematic configuration diagram illustrating an example of a general LC/MS.

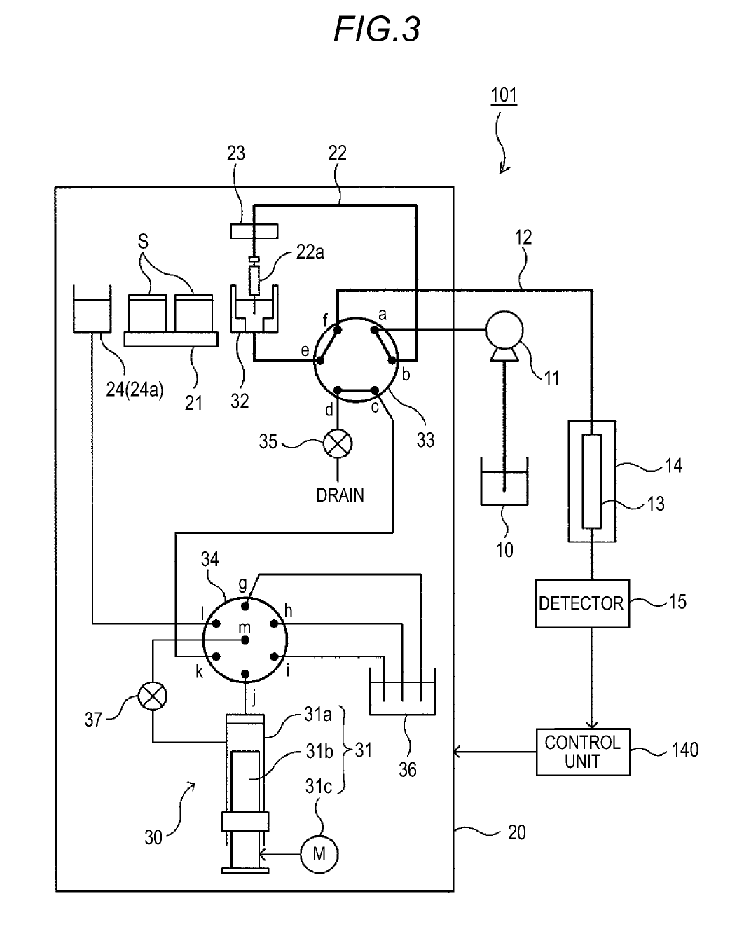

FIG. 4 is a schematic configuration diagram illustrating the same LC/MS as in FIG. 3.

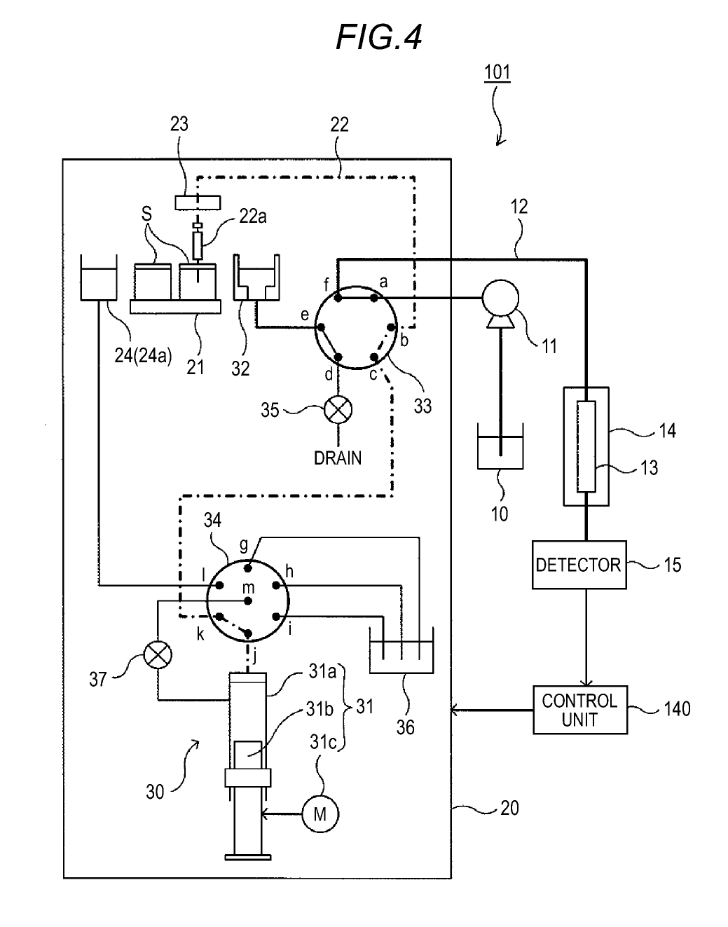

### MODE FOR CARRYING OUT THE INVENTION

Hereinafter, an embodiment of the invention will be described with reference to accompanying drawings. It is a matter of course that the invention is not limited to the embodiment described below and includes various aspects within the scope of the invention.

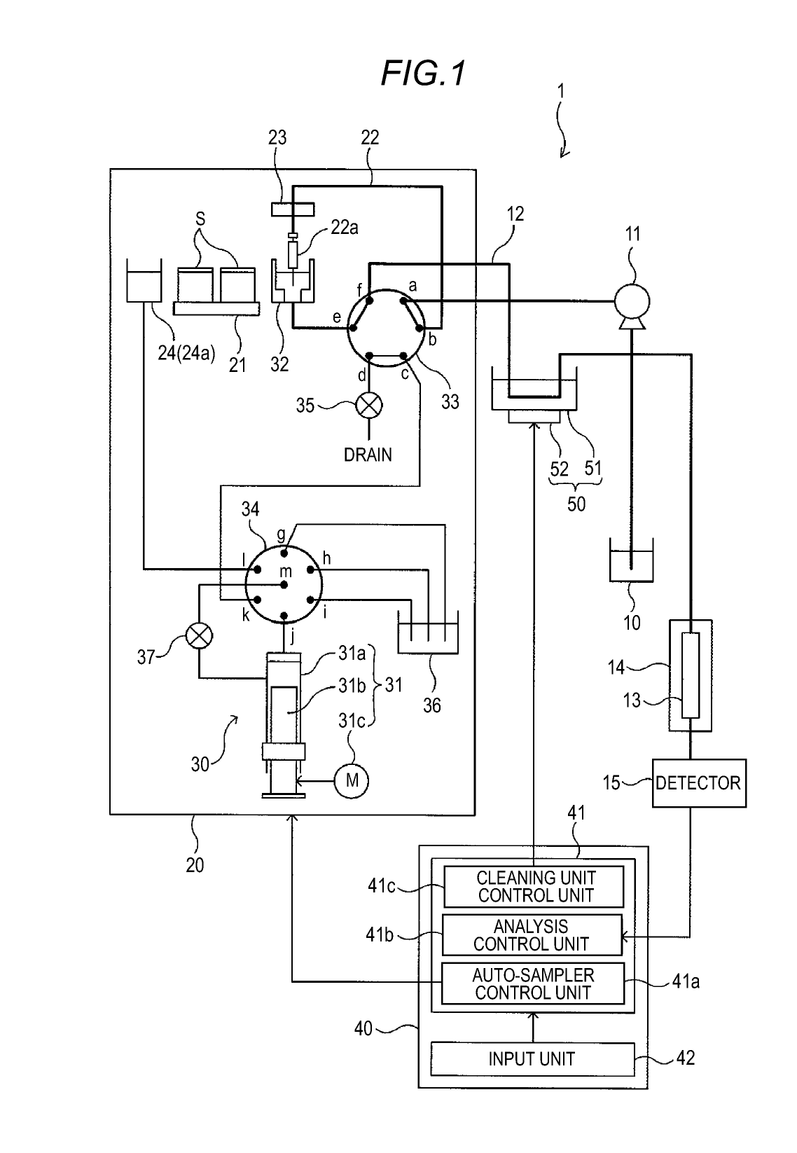

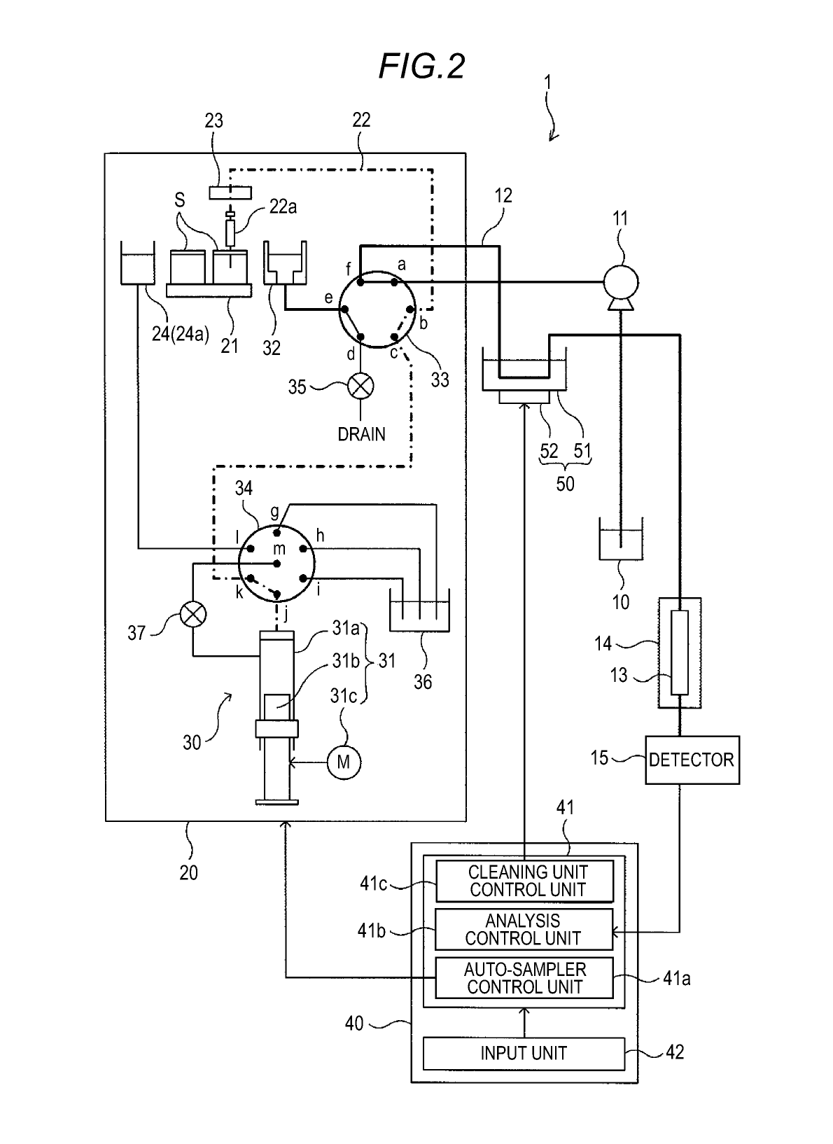

An LC/MS will be used as an example in the following description of a configuration example of a chromatograph device according to the invention, and a schematic configuration thereof is illustrated in FIGS. 1 and 2. The same reference numerals will be used to refer to parts similar to those of the above-described LC/MS 101 according to the related art and description thereof will be omitted.

An LC/MS 1 is provided with a mobile phase reservoir 10 storing a mobile phase, a feed pump 11 connected to the mobile phase reservoir 10, a column coupling tube (column IN side piping) 12, a separation column 13 coupled to the column coupling tube 12, a column thermostat 14 keeping the separation column 13 at a substantially constant temperature, a detector (detection unit) 15 connected to the separation column 13, an auto-sampler 20 injecting a liquid sample into the mobile phase, a controller 40 controlling the LC/MS 1, and a cleaning mechanism 50.

The controller 40 is provided with a CPU 41 and an input unit 42. To describe the functions that are processed by the CPU 41 in blocks, the CPU 41 has an auto-sampler controller 41a controlling the auto-sampler 20, an analysis controller 41b receiving an ion intensity signal from the detector 15, and a cleaning mechanism controller 41c controlling the cleaning mechanism 50. The cleaning mechanism controller 41c performs control for operating an ultrasonic vibrator 52 of the cleaning mechanism 50 after the termination of measurement of one liquid sample and until the initiation of measurement of the next liquid sample.

The cleaning mechanism 50 is provided with a container 51 accommodating water and the ultrasonic vibrator 52 attached to the container 51. The ultrasonic vibrator 52 can be attached to any place (such as the bottom surface) of the container 51 insofar as vibration can be performed. The column coupling tube 12 is immersed in the water in the container 51.

In the cleaning mechanism 50, the ultrasonic vibrator 52 generates ultrasonic waves in the water accommodated in the container 51. The ultrasonic waves generated at this time are non-coherent compression waves and vibrate the column coupling tube 12 immersed in the water by being reflected by the inner wall of the container 51. As a result, the vibration is uniformly transmitted and a residual component in the column coupling tube 12 can be effectively removed.

The vibration of the ultrasonic vibrator 52 is controlled by the cleaning mechanism controller 41c. In addition, it is preferable that the vibration frequency of the ultrasonic vibrator 52 is 20 to 80 kHz inclusive so that the standing waves of the ultrasonic waves are sufficiently generated with respect to the water accommodated in the container 51. Sufficient residual component cleaning may be impossible in a case where the vibration frequency of the ultrasonic vibrator 52 is less than 20 kHz and an increase in analysis (cleaning) time arises in a case where the vibration frequency of the ultrasonic vibrator 52 exceeds 80 kHz. In addition, it is preferable that the operating time of the ultrasonic vibrator 52 is 20 to 120 seconds inclusive so that the effect of the ultrasonic waves is obtained without an increase in analysis time.

An analysis method for automatically and continuously analyzing multiple liquid samples by using the LC/MS 1 will be described below. Firstly, the auto-sampler controller 41a of the controller 40 controls ports a to m of a flow path switching valve 33 and a flow path switching valve 34 such that the ports a to m are in the state that is illustrated in FIG. 2. Accordingly, the mobile phase supplied via the feed pump 11 from the mobile phase reservoir 10 is sent to the separation column 13 through the column coupling tube 12. Next, the auto-sampler controller 41a performs a movement such that a desired sample vial S comes directly below a needle 22a, and then inserts the needle 22a into the sample vial S by lowering the needle 22a. Then, the auto-sampler controller 41a fills a sample introduction tube 22 with the liquid sample in the sample vial S by pulling a plunger 31b of a syringe pump 31.

Next, the auto-sampler controller 41a moves an injection port 32 such that the injection port 32 is directly below the needle 22a, and then inserts the needle 22a into the injection port 32 by lowering the needle 22a. Then, the auto-sampler controller 41a controls the ports a to m of the flow path switching valves 33 and 34 such that the ports a to m are in the state that is illustrated in FIG. 1. Accordingly, the mobile phase supplied via the feed pump 11 from the mobile phase reservoir 10 is sent to the column coupling tube 12 through the sample introduction tube 22, the needle 22a, and the injection port 32. At this time, the liquid sample with which the sample introduction tube 22 is filled is sent to the column coupling tube 12 with the mobile phase, is subjected to component separation in the separation column 13, and then is subjected to sequential detection by the detector 15.

Subsequently, the auto-sampler controller 41a controls the ports a to m of the flow path switching valves 33 and 34, such that the ports a to m are in the state that is illustrated in FIG. 2, after injecting the liquid sample into the column coupling tube 12. Next, the auto-sampler controller 41a moves a rinse port 24 such that the rinse port 24 is directly below the needle 22a, and then inserts the needle 22a into the rinse port 24 by lowering the needle 22a. Then, the auto-sampler controller 41a allows the cleaning solution in a container 36 to flow into the sample introduction tube 22 by pulling and inserting the plunger 31b.

After the liquid sample measurement, the cleaning mechanism controller 41c operates the ultrasonic vibrator 52 for a predetermined time. Subsequently, the auto-sampler controller 41a performs control for measuring the next liquid sample by the same procedure as above.

In the LC/MS 1 that has the configuration according to the invention as described above, the inside of the column coupling tube 12 is reliably cleaned, and thus the occurrence of a carry-over phenomenon can be suppressed. In addition, waiting time for stabilization of the separation column 13 is unnecessary because a cleaning solution different from the mobile phase does not have to flow into the column coupling tube 12.

### Another Embodiment

The above-described LC/MS 1 is configured such that the ultrasonic vibrator 52 is attached to the container 51. Alternatively, the ultrasonic vibrator 52 may be attached to the column coupling tube 12 or the ultrasonic vibrator 52 may be attached to a preheater section after the preheater section is provided.

### INDUSTRIAL APPLICABILITY

The invention can be used in, for example, a liquid chromatograph device measuring multiple liquid samples.

### REFERENCE SIGNS LIST

1 LC/MS (chromatograph device)
12 Column coupling tube
13 Separation column
15 Detector (detection unit)
22 Sample introduction tube
22a Needle
30 Sample injector
52 Ultrasonic vibrator

1-5. (canceled)

6. A chromatograph device comprising:
a sample injector collecting a liquid sample and injecting a predetermined amount of liquid sample into a mobile phase;
a sample introduction tube a distal end section of which has a needle formed therein and a terminal end section of which is connected to the sample injector;
a separation column which is coupled via a column coupling tube to the sample injector, and through which the mobile phase where the liquid sample has been injected passes;
a detector connected to the separation column and detecting a component in the liquid sample; and
a cleaning mechanism including a container in which water is accommodated and the column coupling tube is immersed in the water and an ultrasonic vibrator attached to the container and removing a residual component in the column coupling tube by the ultrasonic vibrator vibrating the column coupling tube by generating ultrasonic waves.

7. The chromatograph device according to claim 6, comprising:
a needle driver moving the needle; and
a table where a plurality of sample containers accommodating liquid samples are placed.

8. The chromatograph device according to claim 7, comprising a controller operating the ultrasonic vibrator between liquid sample measurement and liquid sample measurement.

9. The chromatograph device according to claim 6, wherein a vibration frequency of the ultrasonic vibrator is 20 to 80 kHz inclusive.

10. The chromatograph device according to claim 6, wherein the sample injector includes
a syringe pump collecting a predetermined amount of liquid sample, and
a port valve interconnecting the syringe pump and the sample introduction tube or interconnecting the sample introduction tube and the column coupling tube.
